(19) United States
(12) Patent Application Publication
(10) Pub. No.: US 2026/0052362 A1
(43) Pub. Date: Feb. 19, 2026

(54) PERSONAL IOT NETWORK INFORMATION UPDATING METHOD AND APPARATUS, COMMUNICATION DEVICE AND STORAGE MEDIUM

(71) Applicant: Beijing Xiaomi Mobile Software Co., Ltd., Beijing (CN)

(72) Inventor: Jianning LIU, Beijing (CN)

(21) Appl. No.: 19/101,750

(22) PCT Filed: Aug. 9, 2022
(86) PCT No.: PCT/CN2022/111283

§ 371 Date: Feb. 6, 2025

(51) Int. Cl. H04W 4/50; H04W 76/14; H04W 84/18

(52) U.S. Cl. CPC H04W 4/50; H04W 76/14; H04W 84/18

(57) ABSTRACT

A method for updating personal IoT network (PIN) information is executed by a first network function. The method includes: sending indication information to a second network function serving a PIN element (PINE), wherein the indication information is configured to indicate updated PIN information, and the PINE is an element related to the updated PIN information.

### CROSS REFERENCE TO RELATED APPLICATIONS

The present application is a U.S. national phase of International Application No. PCT/CN2022/111283, filed on Aug. 9, 2022, the disclosure of which is incorporated herein by reference in its entirety.

### TECHNICAL FIELD

The present disclosure relates to but is not limited to the field of communication technologies, and in particular to methods and apparatuses for updating personal IoT network (PIN) information, a communication device and a storage medium.

### BACKGROUND

A PIN consists of PIN elements that communicate using a PIN direct connection or a direct network connection and is managed locally (for example, using a PIN element with management capability to manage). The PIN elements can be wearable devices, smart homes or smart office equipment. Via a PIN element with gateway capability, the PIN elements have access to network services and can communicate with PIN elements that are not within range to use the PIN direct connection. a PIN includes at least one PIN element with gateway capability and at least one PIN element with management capability. In the related art, how to update related parameters of the PIN is a problem that needs to be considered.

### SUMMARY

According to a first aspect of the present disclosure, there is provided a method for updating personal IoT network (PIN) information, executed by a first network function, including: sending indication information to a second network function serving a PIN element (PINE), where the indication information is configured to indicate updated PIN information, and the PINE is an element related to the updated PIN information.

According to a second aspect of the present disclosure, there is provided a method for updating personal IoT network (PIN) information, executed by a third network function, including: receiving request information sent by a first network function, where the request information is configured to request to obtain information of a second network function serving a PIN element (PINE), and the PINE is an element related to updated PIN information.

According to a third aspect of the present disclosure, there is provided a method for updating personal IoT network (PIN) information, executed by a second network function, including: receiving indication information sent by a first network function, where the indication information is configured to indicate updated PIN information, the second network function serves a PIN element (PINE), and the PINE is an element related to the updated PIN information.

According to a fourth aspect of the present disclosure, there is provided a communication device, including: one or more processors; and a memory for storing executable instructions of the one or more processors, where one or more processors are configured to, when executing the executable instructions, implement the method described in any embodiment of the present disclosure.

According to a fifth aspect of an embodiment of the present disclosure, there is provided a computer storage medium storing computer executable programs which, when executed by a processor, implement the method described in any embodiment of the present disclosure.

In the embodiments of the present disclosure, indication information is sent to the second network function serving the PIN element (PINE), where the indication information is configured to indicate updated PIN information, and the PINE is the element related to the updated PIN information. Here, since the second network function serving the PIN element (PINE) can receive the indication information indicating the updated PIN information, the second network function can send the updated PIN information to the PINEs served by the second network function and impacted by the update to the PIN information, compared with only sending the updated PIN information to elements whose PIN is updated, all the PINEs impacted by the update to the PIN information can receive the updated PIN information and update the PIN information in time.

### BRIEF DESCRIPTION OF THE DRAWINGS

The accompanying drawings, which are incorporated in and constitute a part of this specification, illustrate embodiments consistent with the present disclosure and together with the specification serve to explain principles of embodiments of the present disclosure.

FIG. 1 is a schematic structural diagram illustrating a wireless communication system according to an exemplary embodiment.

FIG. 2 is a schematic flowchart illustrating a method for updating PIN information according to an exemplary embodiment.

FIG. 3 is a schematic flowchart illustrating a method for updating PIN information according to an exemplary embodiment.

FIG. 4 is a schematic flowchart illustrating a method for updating PIN information according to an exemplary embodiment.

FIG. 5 is a schematic flowchart illustrating a method for updating PIN information according to an exemplary embodiment.

FIG. 6 is a schematic flowchart illustrating a method for updating PIN information according to an exemplary embodiment.

FIG. 7 is a schematic flowchart illustrating a method for updating PIN information according to an exemplary embodiment.

FIG. 8 is a schematic flowchart illustrating a method for updating PIN information according to an exemplary embodiment.

FIG. 9 is a schematic flowchart illustrating a method for updating PIN information according to an exemplary embodiment.

FIG. 10 is a schematic flowchart illustrating a method for updating PIN information according to an exemplary embodiment.

FIG. 11 is a schematic flowchart illustrating a method for updating PIN information according to an exemplary embodiment.

FIG. 12 is a schematic flowchart illustrating a method for updating PIN information according to an exemplary embodiment.

FIG. 13 is a schematic flowchart illustrating a method for updating PIN information according to an exemplary embodiment.

FIG. 14 is a schematic structural diagram illustrating an apparatus for updating PIN information according to an exemplary embodiment.

FIG. 15 is a schematic structural diagram illustrating an apparatus for updating PIN information according to an exemplary embodiment.

FIG. 16 is a schematic structural diagram illustrating an apparatus for updating PIN information according to an exemplary embodiment.

FIG. 17 is a schematic structural diagram illustrating an apparatus for updating PIN information according to an exemplary embodiment.

FIG. 18 is a schematic structural diagram of a terminal according to an exemplary embodiment.

### DETAILED DESCRIPTION OF THE EMBODIMENTS

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the present disclosure. Instead, they are merely examples of apparatuses and methods consistent with aspects related to embodiments of the present disclosure as recited in the appended claims.

Terms used in embodiments of the present disclosure are for describing some embodiments only, and are not intended to limit the embodiments of the present disclosure. As used in embodiments of the present disclosure and the appended claims, “a/an” and “the” in singular forms are also intended to include plural forms unless the context clearly indicates otherwise. It could also be understood that the term “and/or” as used herein refers to and includes any and all possible combinations of one or more associated listed items.

It could be understood that although the embodiments of the present disclosure may use the terms “first”, “second”, “third”, and the like, to describe various information, but the information is not limited to these terms. These terms are only used to distinguish information of the same type from each other. For example, without departing from the scope of embodiments of the present disclosure, first information may also be called second information, and similarly second information may also be called first information. Depending on the context, the words “if” and “whether” as used herein may be interpreted as “upon” or “when” or “in response to determining”.

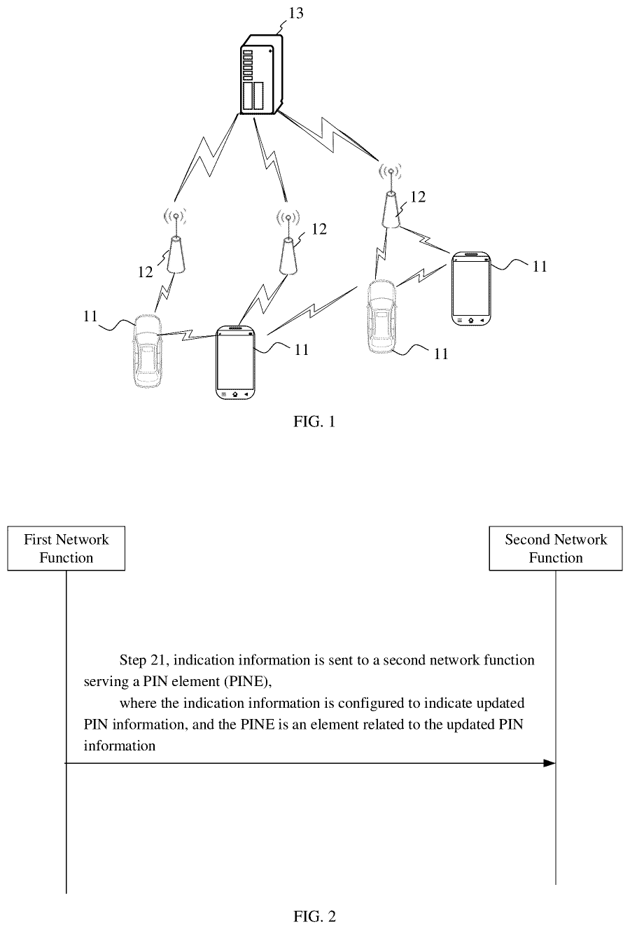

Referring to FIG. 1, FIG. 1 is a schematic structural diagram illustrating a wireless communication system according to an exemplary embodiment. As shown in FIG. 1, the wireless communication system is a communication system based on a cellular mobile communication technology, and the wireless communication system can include a plurality of terminals 11 and a plurality of base stations 12.

The terminal 11 may be a device that provides voice and/or data connectivity to a user. The terminal 11 may communicate with one or more core networks via a radio access network (RAN). The terminal 11 may be an Internet of Things terminal, for example, a sensor device, a mobile phone (or called a “cellular” phone) and a computer having an Internet of Things terminal. For example, the terminal 11 may be a fixed, portable, pocket, hand-held, built-in computer or vehicle-mounted device. For example, the terminal 11 may be a station (STA), a subscriber unit, a subscriber station, a mobile station, a mobile, a remote station, an access point, a remote terminal, an access terminal, a user terminal, a user agent, a user device, or a user equipment (UE). Alternatively, the terminal 11 may be a device of an unmanned aerial vehicle. Alternatively, the terminal 11 may be a vehicle-mounted device, for example, a trip computer with a wireless communication function, or a wireless communication device externally connected to the trip computer. Alternatively, the terminal 11 may also be a roadside device, for example, it may be a street lamp, a signal lamp, or other roadside devices with a wireless communication function.

The base station 12 may be a network side device in a wireless communication system. The wireless communication system may be the fourth generation mobile communication technology (4G) system, also known as a long term evolution (LTE) system. Alternatively, the wireless communication system may also be the fifth generation mobile communication technology (5G) system, also called a new radio (NR) system or 5G NR system. Alternatively, the wireless communication system may also be any generation system. an access network in the 5G system may be called a new generation-radio access network (NG-RAN). Alternatively, the wireless communication system may also be a machine type communication (MTC) system.

The base station 12 may be an evolved base station (eNB) adopted in a 4G system. Alternatively, the base station 12 may also be a central distributed architecture base station (gNB) in the 5G system. When the base station 12 adopts a central distributed architecture, the base station 12 generally includes a central unit (CU) and at least two distributed units (DU). The central unit is provided with a protocol stack of a packet data convergence protocol (PDCP) layer, a radio link control (RLC) layer, or a media access control (MAC) layer. a protocol stack of a physical (PHY) layer is provided in the distributed unit. The specific implementation manner of the base station 12 is not limited in the embodiments of the present disclosure.

A wireless connection may be established between the base station 12 and the terminal 11 through a wireless air interface. In some embodiments, the wireless air interface is a wireless air interface based on the fourth generation mobile communication network technology (4G) standard. Alternatively, the wireless air interface is a wireless air interface based on the fifth generation mobile communication network technology (5G) standard. For example, the wireless air interface is a new radio. Alternatively, the wireless air interface may also be a wireless air interface based on a next generation mobile communication network technology standard based on 5G.

In some embodiments, an E2E (end to end) connection may also be established between terminals 11, for example, a V2V (vehicle to vehicle) communication, a V2I (vehicle to infrastructure) communication and a V2P (vehicle to pedestrian) communication in vehicle to everything (V2X) communication scenes.

In some embodiments, the above-mentioned wireless communication system may further include a network management device 13.

Execution subjects involved in the embodiments of the present disclosure include, but are not limited to, terminals (the user equipment, UE) in cellular mobile communication systems, and base stations of the cellular mobile communication.

In order to better understand the embodiments of the present disclosure, application scenarios of wireless communication of PIN will be described below.

In one embodiment, in order to support necessary procedures regarding to a PIN, for example, a communication between PIN elements (PINEs), PINE discovery, PIN element with gateway capability (PEGC) discovery, PIN element with management capability (PEMC) discovery, an authorization for the PINE, an authorization for the PEGC and/or an authorization of the PEMC, and necessary policies and/or parameter configurations are needed. Related technologies include: 1. whether and how the PIN related policies and parameters identified in other KIs for PIN discovery, the PINE discovery, the authentication and/or authorization for PINE and PIN communication are configured to the PEMC, PEGC and/or PINE; 2. whether and how a core network supports provisioning of configuration information to the PEGC for access control.

As shown in FIG. 2, an embodiment of the present disclosure provides a method for updating personal IoT network (PIN) information. The method is executed by a first network function and includes:
step 21, indication information is sent to a second network function serving a PIN element (PINE),
where the indication information is configured to indicate updated PIN information, and the PINE is an element related to the updated PIN information.

Here, the PINE involved in the present disclosure can be an element in a PIN, and the PINE can be a normal PIN element, a PEGC or a PEMC, where the normal PIN element can be a PIN element without gateway capability and management capability. It should be noted that the PIN can include at least one PEGC and at least one PEMC.

Here, the PIN element can be a terminal. The terminal involved in the present disclosure can be, but is not limited to, mobile phones, a wearable device, a vehicle terminal, a road side unit (RSU), a smart home terminal, an industrial sensing device and/or a medical device. In some embodiments, the terminal may be a Redcap terminal or a new air interface (NR) terminal of a predetermined version (for example, an NR terminal of R17).

The base station involved in the present disclosure can be various types of base stations, for example, a base station of a fifth generation mobile communication (5G) network or other evolved base stations.

The network function involved in the present disclosure can be various types of network functions, for example, a network function of the fifth generation mobile communication (5G) network or other evolved network functions. The network function can be an access and mobility management function (AMF), a PIN management function (PMF), a unified data management (UDM) function, and the like.

In one embodiment, the second network function is the AMF. Each PINE can be associated with an AMF. The AMF associated with the PINE is an AMF serving the PINE.

In one embodiment, the PIN is updated in response to a predetermined event being triggered. The predetermined event includes at least one of the following: a valid time of the PINE expires; a PINE is added to a PIN; the PINE leaves the PIN; the PINE in the PIN is updated; the valid time of the PINE is updated; PIN policies are updated; PIN configuration parameters are updated; or a capability of the PINE is updated. In response to the update of the PIN, the PIN information is updated. The updated PIN information includes at least one of the following: information that the valid time of the PINE has expired; information that the PINE has been added to the PIN; information that the PINE has left the PIN; information that the PINE in the PIN has been updated; information that the valid time of the PINE has been updated; information that the PIN policies have been updated; information that the PIN configuration parameters have updated; or information that the capability of the PINE has been updated. Of course, the updated PIN information is not limited to the above examples, but can also include other information of the PINE, for example, power consumption information.

It should be noted that the PINE is impacted by the update to the PIN information may mean that information on which the PINE function depends needs to be updated synchronously with the update of the PIN information. In other words, the PINE is an element that realizes the PINE function based on the updated PIN information. For example, the PEGC is a gateway of the PINE, the PIN information will be updated after the PEGC leaves the PIN, and thus it is necessary for the PINE to obtain the information that the PEGC leaves the PIN. In this scenario, the PINE is a PINE impacted by the update to the PIN information.

In one embodiment, the first network function is the PIN management function (PMF); and the second network function is the access and mobility management function (AMF). The PMF sends indication information to the AMF serving the PIN element (PINE), where the indication information is configured to indicate updated PIN information, and the PINE is impacted by the update to the PIN information.

It should be noted that in some scenarios, the indication information can also be understood as notification information.

In one embodiment, the first network function is a policy control function (PCF), and the second network function is the access and mobility management function (AMF). The PCF sends indication information to the AMF serving the PIN element (PINE), where the indication information is configured to indicate updated PIN information, and the PINE is impacted by the update to the PIN information.

In one embodiment, it is determined to update PIN information, and request information is sent to a third network function, where the request information is configured to request information of the second network function. First response information sent by the third network function is received, where the first response information includes the information of the second network function serving the PINE. Indication information is sent to the second network function serving the PIN element (PINE), where the indication information is configured to indicate updated PIN information, and the PINE is impacted by the update to the PIN information. The first network function is the PIN management function (PMF) or the policy control function (PCF), the second network function is the access and mobility management function (AMF), and the third network function may be the unified data management (UDM) function. In one embodiment, the information of the second network function includes an AMF identifier (ID).

In one embodiment, the request information indicates information of at least one of the following of the PINE:
an identity identifier (ID) of the terminal, where the ID of the terminal may be a PEMC ID, a PINE ID, a subscription permanent identifier (SUPI), a subscription concerted identifier (SUCI), and/or a MAC address; or
a generic public subscription identifier (GPSI).

In one embodiment, the PINE is determined in response to determining to update the PIN information. The indication information is sent to the second network function serving the PIN element (PINE), where the indication information is configured to indicate updated PIN information, and the PINE is impacted by the update to the PIN information.

For example, the identity identifier (ID) and/or the generic public subscription identifier (GPSI) of the terminal of the PINE are determined in response to determining to update the PIN information. The indication information is sent to the second network function serving the PIN element (PINE) based on the identity identifier (ID) and/or the generic public subscription identifier (GPSI), where the indication information is configured to indicate updated PIN information, and the PINE is impacted by the update to the PIN information.

In one embodiment, the PINE is determined in response to determining to update the PIN information. It is determined to update the PIN information, and the request information is sent to the third network function, where the request information is configured to request information of the second network function. First response information sent by the third network function is received, where the first response information includes the information of the second network function serving the PINE. The indication information is sent to the second network function serving the PIN element (PINE), where the indication information is configured to indicate updated PIN information, and the PINE is impacted by the update to the PIN information.

In one embodiment, it is determined that a predetermined event is triggered, and it is determined to update the PIN information, where the predetermined event includes at least one of the following: a valid time of the PINE expires; a PINE is added to a PIN; the PINE leaves the PIN; the PINE in the PIN is updated; the valid time of the PINE is updated; PIN policies are updated; PIN configuration parameters are updated; or a capability of the PINE is updated. The indication information is sent to the second network function serving the PIN element (PINE), where the indication information is configured to indicate updated PIN information, and the PINE is impacted by the update to the PIN information.

In one embodiment, it is determined that the predetermined event is triggered, and it is determined to update the PIN information, where the predetermined event includes at least one of the following: the valid time of the PINE expires; the PINE is added to the PIN; the PINE leaves the PIN; the PINE in the PIN is updated; the valid time of the PINE is updated; PIN policies are updated; PIN configuration parameters are updated; or the capability of the PINE is updated. It is determined to update the PIN information, and the request information is sent to the third network function, where the request information is configured to request information of the second network function. First response information sent by the third network function is received, where the first response information includes the information of the second network function serving the PINE. The indication information is sent to the second network function serving the PIN element (PINE), where the indication information is configured to indicate updated PIN information, and the PINE is impacted by the update to the PIN information.

In one embodiment, the first network function is the UDM function, and the second network function is the access and mobility management function (AMF). The UDM function sends indication information to the AMF serving the PIN element (PINE), where the indication information is configured to indicate updated PIN information, and the PINE is impacted by the update to the PIN information.

In one embodiment, the first network function is the UDM function, and the second network function is the access and mobility management function (AMF). In response to determining that the PIN information is updated, the UDM function sends indication information to the AMF serving the PIN element (PINE), where the indication information is configured to indicate updated PIN information, and the PINE is impacted by the update to the PIN information. Here, the UDM function may be to determine that the PIN information is updated according to context information or to determine the PIN information is updated based on an application Function (AF).

In one embodiment, the indication information is sent to the second network function serving the PIN element (PINE), where the indication information is configured to indicate updated PIN information, and the PINE is impacted by the update to the PIN information. Receiving the second response information sent by the AMF.

In the embodiments of the present disclosure, the indication information is sent to the second network function serving the PIN element (PINE), where the indication information is configured to indicate updated PIN information, and the PINE is impacted by the update to the PIN information. Here, since the second network function serving the PIN element (PINE) can receive the indication information indicating the updated PIN information, the second network function can send the updated PIN information to the PINEs served by the second network function and impacted by the update to the PIN information, compared with only sending the updated PIN information to elements whose PIN is updated, all the PINEs impacted by the update to the PIN information can receive the updated PIN information and update the PIN information in time.

It should be noted that a person skilled in the art can understand that the methods provided in the embodiments of the present disclosure can be executed alone or together with some methods in the embodiments of the present disclosure or some methods in the related art.

As shown in FIG. 3, an embodiment of the present disclosure provides a method for updating personal IoT network (PIN) information. The method is executed by a first network function and includes:
step 31, it is determined to update PIN information, and request information is sent to a third network function,
where the request information is configured to request information of the second network function.

In one embodiment, the first network function is the PIN management function (PMF) or the policy control function (PCF), and the second network function is the access and mobility management function (AMF).

In one embodiment, the request information indicates information of at least one of the following of the PINE:
an identity identifier (ID) of the terminal, where the ID of the terminal may be a PEMC ID, a PINE ID, a subscription permanent identifier (SUPI), a subscription concerted identifier (SUCI), and/or a MAC address; or
a generic public subscription identifier (GPSI).

In one embodiment, it is determined to update the PIN information, and the request information is sent to the third network function, where the request information is configured to request information of the second network function. First response information sent by the third network function is received, where the first response information includes the information of the second network function serving the PINE. The indication information is sent to the second network function serving the PIN element (PINE), where the indication information is configured to indicate updated PIN information, and the PINE is impacted by the update to the PIN information. The first network function is the PIN management function (PMF) or the policy control function (PCF), the second network function is the access and mobility management function (AMF), and the third network function may be the UDM function. In one embodiment, the information of the second network function includes an AMF identifier (ID).

In one embodiment, it is determined that the predetermined event is triggered, and it is determined to update the PIN information, where the predetermined event includes at least one of the following: the valid time of the PINE expires; the PINE is added to the PIN; the PINE leaves the PIN; the PINE in the PIN is updated; the valid time of the PINE is updated; PIN policies are updated; PIN configuration parameters are updated; or the capability of the PINE is updated. It is determined to update the PIN information, and the request information is sent to the third network function, where the request information is configured to request information of the second network function. First response information sent by the third network function is received, where the first response information includes the information of the second network function serving the PINE. The indication information is sent to the second network function serving the PIN element (PINE), where the indication information is configured to indicate updated PIN information, and the PINE is impacted by the update to the PIN information.

In one embodiment, the PINE is determined in response to determining to update the PIN information. It is determined to update the PIN information, and the request information is sent to the third network function, where the request information is configured to request information of the second network function. First response information sent by the third network function is received, where the first response information includes the information of the second network function serving the PINE. The indication information is sent to the second network function serving the PIN element (PINE), where the indication information is configured to indicate updated PIN information, and the PINE is impacted by the update to the PIN information.

It should be noted that a person skilled in the art can understand that the methods provided in the embodiments of the present disclosure can be executed alone or together with some methods in the embodiments of the present disclosure or some methods in the related art.

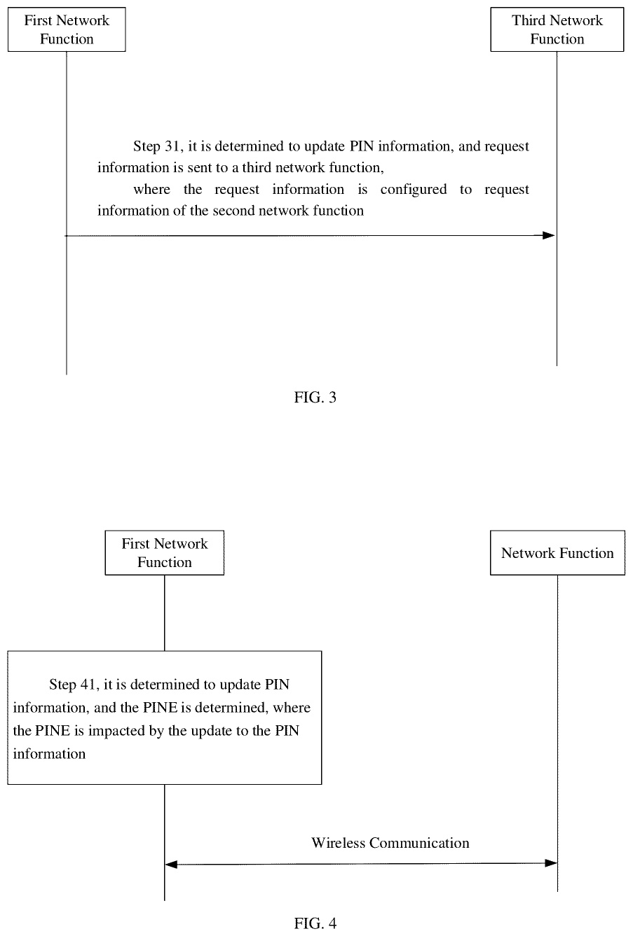

As shown in FIG. 4, an embodiment of the present disclosure provides a method for updating personal IoT network (PIN) information. The method is executed by a first network function and includes:
step 41, it is determined to update PIN information, and the PINE is determined, where the PINE is impacted by the update to the PIN information.

In one embodiment, the PINE is determined in response to determining to update the PIN information. The indication information is sent to the second network function serving the PIN element (PINE), where the indication information is configured to indicate updated PIN information, and the PINE is impacted by the update to the PIN information.

For example, the identity identifier (ID) and/or the generic public subscription identifier (GPSI) of the terminal of the PINE are determined in response to determining to update the PIN information. The indication information is sent to the second network function serving the PIN element (PINE) based on the identity identifier (ID) and/or the generic public subscription identifier (GPSI), where the indication information is configured to indicate updated PIN information, and the PINE is impacted by the update to the PIN information.

In one embodiment, the PINE is determined in response to determining to update the PIN information. It is determined to update the PIN information, and the request information is sent to the third network function, where the request information is configured to request information of the second network function. First response information sent by the third network function is received, where the first response information includes the information of the second network function serving the PINE. The indication information is sent to the second network function serving the PIN element (PINE), where the indication information is configured to indicate updated PIN information, and the PINE is impacted by the update to the PIN information. The first network function is the PIN management function (PMF) or the policy control function (PCF), and the second network function is the access and mobility management function (AMF).

It should be noted that a person skilled in the art can understand that the methods provided in the embodiments of the present disclosure can be executed alone or together with some methods in the embodiments of the present disclosure or some methods in the related art.

As shown in FIG. 5, an embodiment of the present disclosure provides a method for updating personal IoT network (PIN) information. The method is executed by a first network function and includes:
step 51, it is determined that a predetermined event is triggered, and determining to update the PIN information;
where the predetermined event includes at least one of: a valid time of the PINE expires; a PINE is added to a PIN; the PINE leaves the PIN; the PINE in the PIN is updated; the valid time of the PINE is updated; PIN policies are updated; PIN configuration parameters are updated; or a capability of the PINE is updated.

In one embodiment, it is determined that the predetermined event is triggered, and it is determined to update the PIN information, where the predetermined event includes at least one of the following: the valid time of the PINE expires; the PINE is added to the PIN; the PINE leaves the PIN; the PINE in the PIN is updated; the valid time of the PINE is updated; PIN policies are updated; PIN configuration parameters are updated; or the capability of the PINE is updated. The indication information is sent to the second network function serving the PIN element (PINE), where the indication information is configured to indicate updated PIN information, and the PINE is impacted by the update to the PIN information.

In one embodiment, it is determined that the predetermined event is triggered, and it is determined to update the PIN information, where the predetermined event includes at least one of the following: the valid time of the PINE expires; the PINE is added to the PIN; the PINE leaves the PIN; the PINE in the PIN is updated; the valid time of the PINE is updated; PIN policies are updated; PIN configuration parameters are updated; or the capability of the PINE is updated. It is determined to update the PIN information, and the request information is sent to the third network function, where the request information is configured to request information of the second network function. First response information sent by the third network function is received, where the first response information includes the information of the second network function serving the PINE. The indication information is sent to the second network function serving the PIN element (PINE), where the indication information is configured to indicate updated PIN information, and the PINE is impacted by the update to the PIN information. The first network function is the PIN management function (PMF) or the policy control function (PCF), and the second network function is the access and mobility management function (AMF).

It should be noted that a person skilled in the art can understand that the methods provided in the embodiments of the present disclosure can be executed alone or together with some methods in the embodiments of the present disclosure or some methods in the related art.

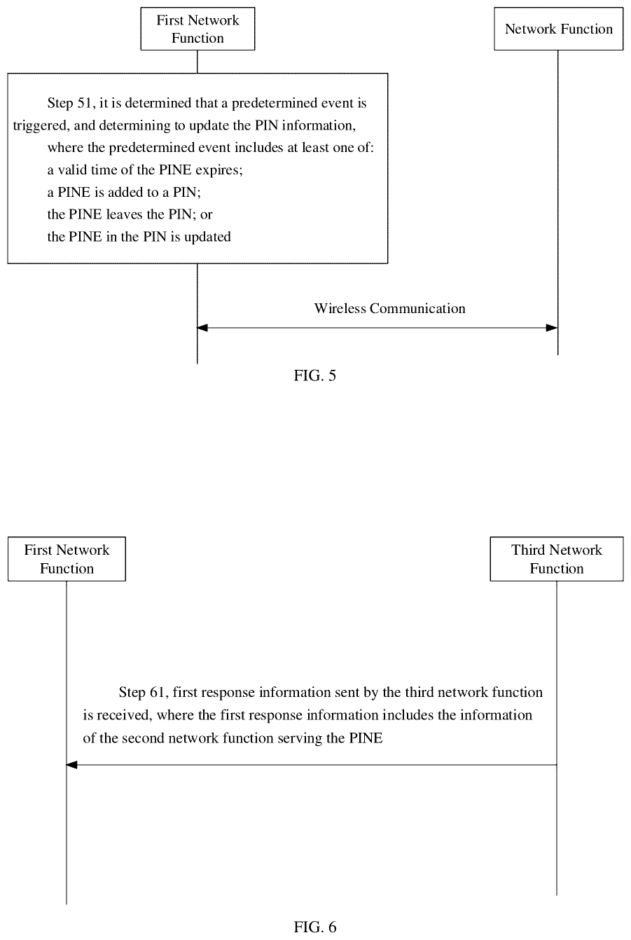

As shown in FIG. 6, an embodiment of the present disclosure provides a method for updating personal IoT network (PIN) information. The method is executed by a first network function and includes:
step 61, first response information sent by the third network function is received,
where the first response information includes the information of the second network function serving the PINE.

The description of step 61 refers to the description of step 31, and will not be repeated here.

It should be noted that a person skilled in the art can understand that the methods provided in the embodiments of the present disclosure can be executed alone or together with some methods in the embodiments of the present disclosure or some methods in the related art.

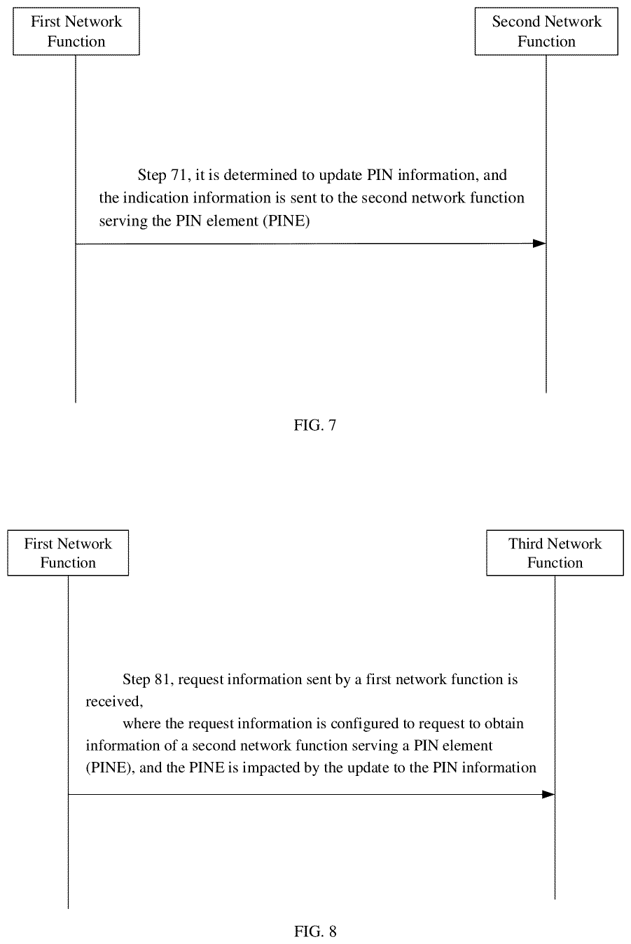

As shown in FIG. 7, an embodiment of the present disclosure provides a method for updating personal IoT network (PIN) information. The method is executed by a first network function and includes:
step 71, it is determined to update PIN information, and the indication information is sent to the second network function serving the PIN element (PINE).

In one embodiment, the first network function is the UDM function, and the second network function is the access and mobility management function (AMF). The UDM sends indication information to the AMF serving the PIN element (PINE), where the indication information is configured to indicate updated PIN information, and the PINE is impacted by the update to the PIN information.

In one embodiment, the first network function is the UDM function, and the second network function is the access and mobility management function (AMF). In response to determining that the PIN information is updated, the UDM function sends indication information to the AMF serving the PIN element (PINE), where the indication information is configured to indicate updated PIN information, and the PINE is impacted by the update to the PIN information. Here, the UDM function may be to determine that the PIN information is updated according to context information or to determine the PIN information is updated based on an application Function (AF).

It should be noted that a person skilled in the art can understand that the methods provided in the embodiments of the present disclosure can be executed alone or together with some methods in the embodiments of the present disclosure or some methods in the related art.

As shown in FIG. 8, an embodiment of the present disclosure provides a method for updating personal IoT network (PIN) information. The method is executed by a third network function and includes:
step 81, request information sent by a first network function is received,
where the request information is configured to request to obtain information of a second network function serving a PIN element (PINE), and the PINE is impacted by the update to the PIN information.

Here, the PINE involved in the present disclosure can be an element in a PIN, and the PINE can be a normal PIN element, a PEGC or a PEMC, where the normal PIN element can be a PIN element without gateway capability and management capability. It should be noted that the PIN can include at least one PEGC and at least one PEMC.

Here, the PIN element can be a terminal. The terminal involved in the present disclosure can be, but is not limited to, mobile phones, a wearable device, a vehicle terminal, a road side unit (RSU), a smart home terminal, an industrial sensing device and/or a medical device. In some embodiments, the terminal may be a Redcap terminal or a new air interface (NR) terminal of a predetermined version (for example, an NR terminal of R17).

The base station involved in the present disclosure can be various types of base stations, for example, a base station of a fifth generation mobile communication (5G) network or other evolved base stations.

The network function involved in the present disclosure can be various types of network functions, for example, a network function of the fifth generation mobile communication (5G) network or other evolved network functions. The network function can be an access and mobility management function (AMF), a PIN management function (PMF), a unified data management (UDM) function, and the like.

In one embodiment, the second network function is the AMF. Each PINE can be associated with an AMF. The AMF associated with the PINE is an AMF serving the PINE.

In one embodiment, the PIN is updated in response to a predetermined event being triggered. The predetermined event includes at least one of the following: a valid time of the PINE expires; a PINE is added to a PIN; the PINE leaves the PIN; the PINE in the PIN is updated; the valid time of the PINE is updated; PIN policies are updated; PIN configuration parameters are updated; or a capability of the PINE is updated. In response to the update of the PIN, the PIN information is updated. The updated PIN information includes at least one of the following: information that the valid time of the PINE has expired; information that the PINE has been added to the PIN; information that the PINE has left the PIN; information that the PINE in the PIN has been updated; information that the valid time of the PINE has been updated; information that the PIN policies have been updated; information that the PIN configuration parameters have updated; or information that the capability of the PINE has been updated. Of course, the updated PIN information is not limited to the above examples, but can also include other information of the PINE, for example, power consumption information.

It should be noted that the PINE is impacted by the update to the PIN information may be that information on which the PINE function depends needs to be updated synchronously with the update of the PIN information. For example, the PEGC is a gateway of the PINE, the PIN information will be updated after the PEGC leaves the PIN, and thus it is necessary for the PINE to obtain the information that the PEGC leaves the PIN. In this scenario, the PINE is a PINE impacted by the update to the PIN information.

In one embodiment, the first network function is the PIN management function (PMF) or the policy control function (PCF), the second network function is the access and mobility management function (AMF), and the third network function may be the UDM function. Request information sent by the first network function is received, where the request information is configured to request information of the second network function. First response information is sent to the first network function, where the first response information includes the information of the second network function serving the PINE. In one embodiment, the information of the second network function includes an AMF identifier (ID).

In one embodiment, the request information indicates information of at least one of the following of the PINE:
an identity identifier (ID) of the terminal, where the ID of the terminal may be a PEMC ID, a PINE ID, and/or a subscription permanent identifier (SUPI); or
a generic public subscription identifier (GPSI).

It should be noted that a person skilled in the art can understand that the methods provided in the embodiments of the present disclosure can be executed alone or together with some methods in the embodiments of the present disclosure or some methods in the related art.

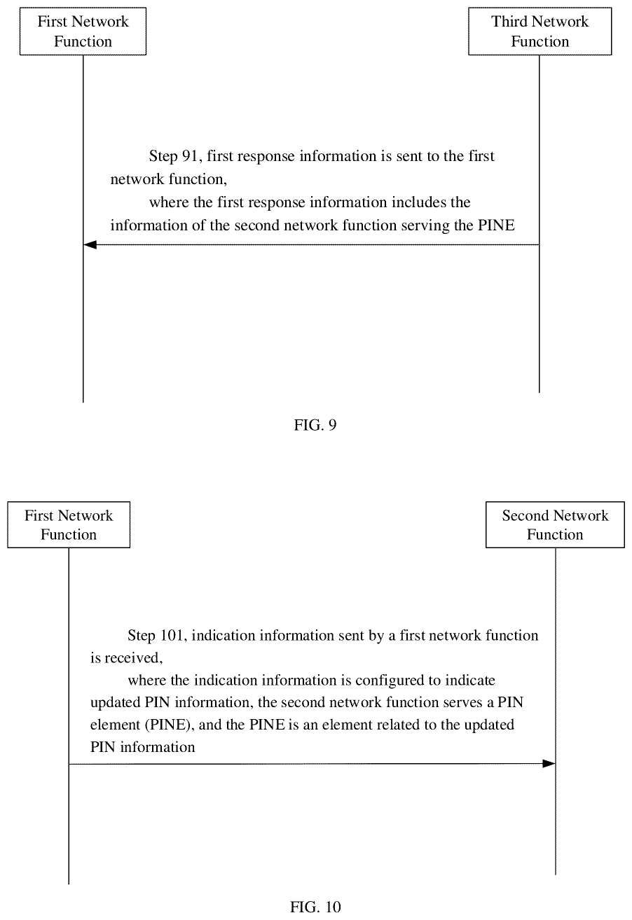

As shown in FIG. 9, an embodiment of the present disclosure provides a method for updating personal IoT network (PIN) information. The method is executed by a third network function and includes:
step 91, first response information is sent to the first network function,
where the first response information includes the information of the second network function serving the PINE.

In one embodiment, the first network function is the PIN management function (PMF) or the policy control function (PCF), the second network function is the access and mobility management function (AMF), and the third network function may be the UDM function. Request information sent by the first network function is received, where the request information is configured to request information of the second network function. First response information is sent to the first network function, where the first response information includes the information of the second network function serving the PINE. In one embodiment, the information of the second network function includes an AMF identifier (ID).

In one embodiment, the request information indicates information of at least one of the following of the PINE:
an identity identifier (ID) of the terminal, where the ID of the terminal may be a PEMC ID, a PINE ID, and/or a subscription permanent identifier (SUPI); or
a generic public subscription identifier (GPSI).

It should be noted that a person skilled in the art can understand that the methods provided in the embodiments of the present disclosure can be executed alone or together with some methods in the embodiments of the present disclosure or some methods in the related art.

As shown in FIG. 10, an embodiment of the present disclosure provides a method for updating personal IoT network (PIN) information. The method is executed by a second network function and includes:
step 101, indication information sent by a first network function is received,
where the indication information is configured to indicate updated PIN information, the second network function serves a PIN element (PINE), and the PINE is impacted by the update to the PIN information.

Here, the PINE involved in the present disclosure can be an element in a PIN, and the PINE can be a normal PIN element, a PEGC or a PEMC, where the normal PIN element can be a PIN element without gateway capability and management capability. It should be noted that the PIN can include at least one PEGC and at least one PEMC.

Here, the PIN element can be a terminal. The terminal involved in the present disclosure can be, but is not limited to, mobile phones, a wearable device, a vehicle terminal, a road side unit (RSU), a smart home terminal, an industrial sensing device and/or a medical device. In some embodiments, the terminal may be a Redcap terminal or a new air interface (NR) terminal of a predetermined version (for example, an NR terminal of R17).

The base station involved in the present disclosure can be various types of base stations, for example, a base station of a fifth generation mobile communication (5G) network or other evolved base stations.

The network function involved in the present disclosure can be various types of network functions, for example, a network function of the fifth generation mobile communication (5G) network or other evolved network functions. The network function can be an access and mobility management function (AMF), a PIN management function (PMF), a unified data management (UDM) function, and the like.

In one embodiment, the second network function is the AMF. Each PINE can be associated with an AMF. The AMF associated with the PINE is an AMF serving the PINE.

In one embodiment, the PIN is updated in response to a predetermined event being triggered. The predetermined event includes at least one of the following: a valid time of the PINE expires; a PINE is added to a PIN; the PINE leaves the PIN; the PINE in the PIN is updated; the valid time of the PINE is updated; PIN policies are updated; PIN configuration parameters are updated; or a capability of the PINE is updated. In response to the update of the PIN, the PIN information is updated. The updated PIN information includes at least one of the following: information that the valid time of the PINE has expired; information that the PINE has been added to the PIN; information that the PINE has left the PIN; information that the PINE in the PIN has been updated; information that the valid time of the PINE has been updated; information that the PIN policies have been updated; information that the PIN configuration parameters have updated; or information that the capability of the PINE has been updated. Of course, the updated PIN information is not limited to the above examples, but can also include other information of the PINE, for example, power consumption information.

It should be noted that the PINE is impacted by the update to the PIN information may be that information on which the PINE function depends needs to be updated synchronously with the update of the PIN information. For example, the PEGC is a gateway of the PINE, the PIN information will be updated after the PEGC leaves the PIN, and thus it is necessary for the PINE to obtain the information that the PEGC leaves the PIN. In this scenario, the PINE is a PINE impacted by the update to the PIN information.

In one embodiment, the first network function is the PIN management function (PMF), and the second network function is the access and mobility management function (AMF). The AMF receives the indication information sent by the PMF, where the indication information is configured to indicate updated PIN information, the AMF serves the PIN element (PINE), and the PINE is impacted by the update to the PIN information.

It should be noted that in some scenarios, the indication information can also be understood as notification information.

In one embodiment, the first network function is a policy control function (PCF), and the second network function is the access and mobility management function (AMF). The AMF receives the indication information sent by the PCF, where the indication information is configured to indicate updated PIN information, the AMF serves the PIN element (PINE), and the PINE is impacted by the update to the PIN information.

In one embodiment, the first network function is the UDM function, and the second network function is the access and mobility management function (AMF). The AMF receives the indication information sent by the UDM function, where the indication information is configured to indicate updated PIN information, the AMF serves the PIN element (PINE), and the PINE is impacted by the update to the PIN information.

In one embodiment, the first network function is the UDM function, and the second network function is the access and mobility management function (AMF). In response to determining that the PIN information is updated, the UDM function sends indication information to the AMF serving the PIN element (PINE), where the indication information is configured to indicate updated PIN information, and the PINE is impacted by the update to the PIN information. Here, the UDM function may be to determine that the PIN information is updated according to context information or to determine the PIN information is updated based on an application Function (AF).

In one embodiment, the first network function is the UDM function, the PCF or the PMF. The indication information sent by the first network function is received, where the indication information is configured to indicate updated PIN information, the second network function serves a PIN element (PINE), and the PINE is impacted by the update to the PIN information. The indication information is sent to the PEMC. The second response information sent by the PEMC is received, and the second response information is sent to the first network function.

It should be noted that the PEMC can send the indication information to the PINEs that need to obtain the indication information.

It should be noted that a person skilled in the art can understand that the methods provided in the embodiments of the present disclosure can be executed alone or together with some methods in the embodiments of the present disclosure or some methods in the related art.

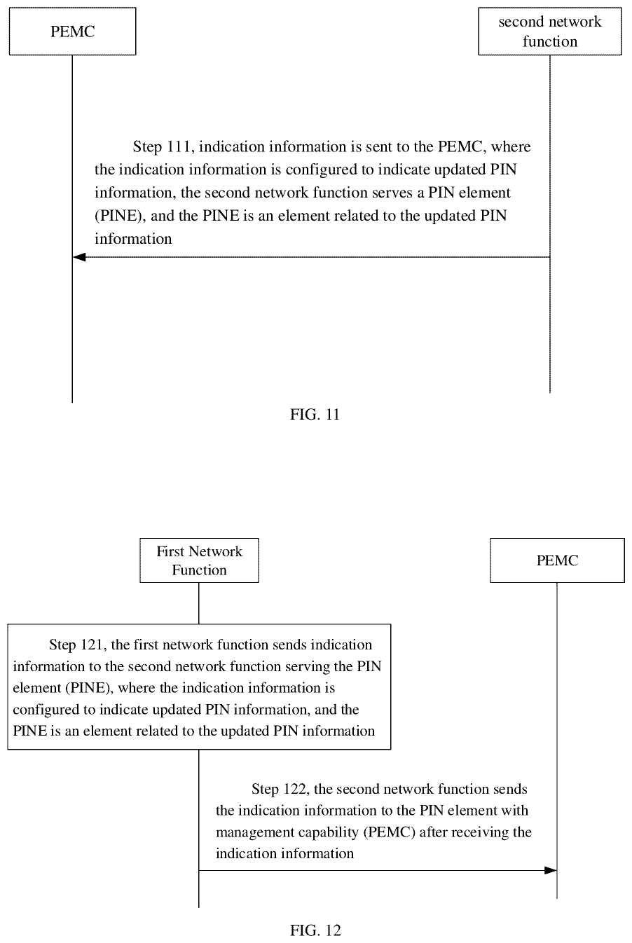

As shown in FIG. 11, an embodiment of the present disclosure provides a method for updating personal IoT network (PIN) information. The method is executed by a second network function and includes:

step 111, indication information is sent to the PEMC, where the indication information is configured to indicate updated PIN information, the second network function serves a PIN element (PINE), and the PINE is impacted by the update to the PIN information.

In one embodiment, the first network function is the UDM function, the PCF or the PMF. The indication information sent by the first network function is received, where the indication information is configured to indicate updated PIN information, the second network function serves a PIN element (PINE), and the PINE is impacted by the update to the PIN information. The indication information is sent to the PEMC. The second response information sent by the PEMC is received, and the second response information is sent to the first network function.

It should be noted that a person skilled in the art can understand that the methods provided in the embodiments of the present disclosure can be executed alone or together with some methods in the embodiments of the present disclosure or some methods in the related art.

As shown in FIG. 12, an embodiment of the present disclosure provides a method for updating personal IoT network (PIN) information. The method is executed by a core network and includes:
step 121, the first network function sends indication information to the second network function serving the PIN element (PINE), where the indication information is configured to indicate updated PIN information, and the PINE is impacted by the update to the PIN information; and
step 122, the second network function sends the indication information to the PIN element with management capability (PEMC) after receiving the indication information.

Here, the PINE involved in the present disclosure can be an element in a PIN, and the PINE can be a normal PIN element, a PEGC or a PEMC, where the normal PIN element can be a PIN element without gateway capability and management capability. It should be noted that the PIN can include at least one PEGC and at least one PEMC.

Here, the PIN element can be a terminal. The terminal involved in the present disclosure can be, but is not limited to, mobile phones, a wearable device, a vehicle terminal, a road side unit (RSU), a smart home terminal, an industrial sensing device and/or a medical device. In some embodiments, the terminal may be a Redcap terminal or a new air interface (NR) terminal of a predetermined version (for example, an NR terminal of R17).

The base station involved in the present disclosure can be various types of base stations, for example, a base station of a fifth generation mobile communication (5G) network or other evolved base stations.

The network function of the core network involved in the present disclosure can be various types of network functions, for example, a network function of the fifth generation mobile communication (5G) network or other evolved network functions. The network function can be an access and mobility management function (AMF), a PIN management function (PMF), a unified data management (UDM) function, and the like.

In one embodiment, the first network function sends indication information to the second network function serving the PIN element (PINE), where the indication information is configured to indicate updated PIN information, and the PINE is impacted by the update to the PIN information; and the second network function sends the indication information to the PIN element with management capability (PEMC) after receiving the indication information. The first network function is the PIN management function (PMF) or the policy control function (PCF), and the second network function is the access and mobility management function (AMF). It should be noted that a person skilled in the art can understand that the methods provided in the embodiments of the present disclosure can be executed alone or together with some methods in the embodiments of the present disclosure or some methods in the related art.

In order to better understand technical solutions of the present disclosure, the technical solutions of the present disclosure will be further explained through an exemplary embodiment.

### EXAMPLE 1

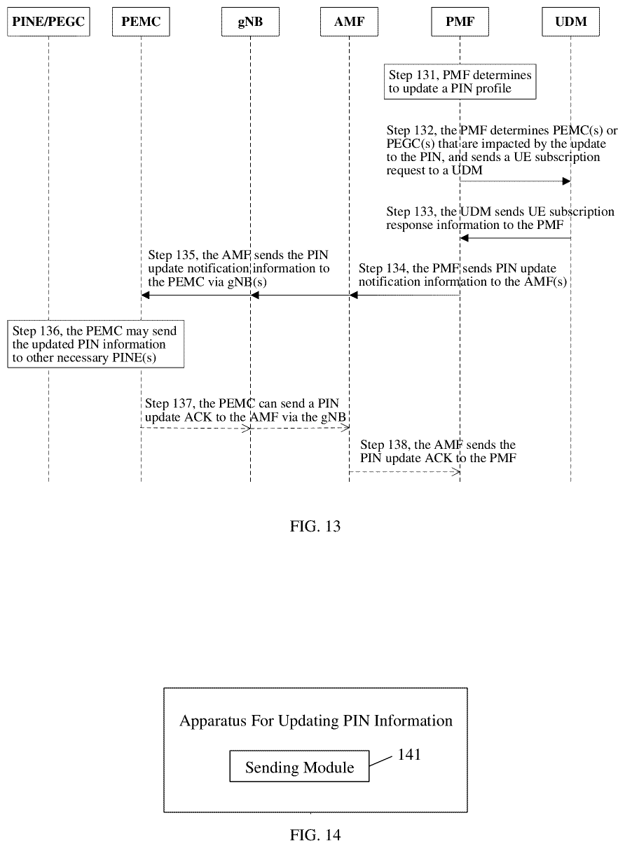

Referring to FIG. 13, an embodiment of the present disclosure provides a method for updating personal IoT network (PIN) information. The method includes following steps:
step 131, a PMF determines to update a PIN profile, where the PIN profile can be updated when a valid time of a PEGC or a PEMC has expired;
step 132, the PMF determines PEMC(s) or PEGC(s) that are impacted by the update to the PIN, and sends a UE subscription request (corresponding to the request information in the present disclosure) to a UDM to obtain AMF ID(s) of AMF(s) serving impacted PEMC(s) or PEGC(s), where the AMF ID(s) include one or more UE IDs or GPSIs;
step 133, the UDM sends UE subscription response information (corresponding to the first response information in the present disclosure) to the PMF, where the UE subscription response information includes the AMF ID(s) corresponding to the PEGC(s) or the PEMC(s);
step 134, the PMF sends PIN update notification information (corresponding to the indication information in the present disclosure) to the AMF(s), where the PIN update notification information includes updated PIN information;
step 135, the AMF sends the PIN update notification information to the PEMC via gNB(s);
step 136, the PEMC may send the updated PIN information to other necessary PINE(s);
step 137, the PEMC can send a PIN update ACK (corresponding to the second response information in the present disclosure) to the AMF via the gNB; and step 138, the AMF sends the PIN update ACK to the PMF.

It should be noted that the PMF in the present disclosure can be the PCF.

As shown in FIG. 14, an embodiment of the present disclosure provides an apparatus for updating personal IoT network (PIN) information, including: a sending module 141 configured to send indication information to a second network function serving a PIN element (PINE), where the indication information is configured to indicate updated PIN information, and the PINE is impacted by the update to the PIN information.

It should be noted that a person skilled in the art can understand that the methods provided in the embodiments of the present disclosure can be executed alone or together with some methods in the embodiments of the present disclosure or some methods in the related art.

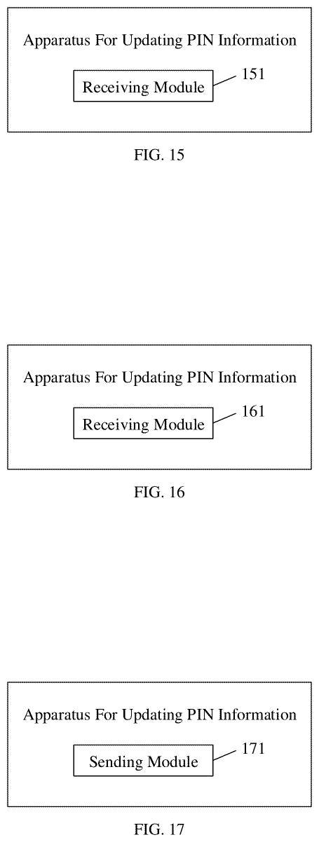

As shown in FIG. 15, an embodiment of the present disclosure provides an apparatus for updating personal IoT network (PIN) information, including: a receiving module 151 configured to receive request information sent by a first network function, where the request information is configured to request to obtain information of a second network function serving a PIN element (PINE), and the PINE is impacted by the update to the PIN information.

It should be noted that a person skilled in the art can understand that the methods provided in the embodiments of the present disclosure can be executed alone or together with some methods in the embodiments of the present disclosure or some methods in the related art.

As shown in FIG. 16, an embodiment of the present disclosure provides an apparatus for updating personal IoT network (PIN) information, including: a receiving module 161 configured to receive indication information sent by a first network function, where the indication information is configured to indicate updated PIN information, the second network function serves a PIN element (PINE), and the PINE is impacted by the update to the PIN information.

It should be noted that a person skilled in the art can understand that the methods provided in the embodiments of the present disclosure can be executed alone or together with some methods in the embodiments of the present disclosure or some methods in the related art.

As shown in FIG. 17, an embodiment of the present disclosure provides an apparatus for updating personal IoT network (PIN) information, including: a sending module 171 configured to send, by a first network function, indication information to a second network function serving a PIN element (PINE), where the indication information is configured to indicate updated PIN information, and the PINE is impacted by the update to the PIN information, where the sending module is further configured to send, by the second network function, the indication information to a PIN element with management capability (PEMC) after receiving the indication information.

It should be noted that a person skilled in the art can understand that the methods provided in the embodiments of the present disclosure can be executed alone or together with some methods in the embodiments of the present disclosure or some methods in the related art.

An embodiment of the present disclosure provides a system for updating personal IoT network (PIN) information, including: a first network function, a second network function and/or a third network function, where the first network function performs any one of the methods executed by the first network function in the present disclosure, the second network function performs any one of the methods executed by the second network function in the present disclosure, and the third network function performs any one of the methods executed by the third network function in the present disclosure.

An embodiment of the present disclosure provides a communication device, including: a processor, and a memory configured to store processor-executable instructions; where the processor is configured to implement the method applied to any embodiment of the present disclosure when the processor-executable instructions are executed.

The processor can include various types of storage medium, which are non-transitory computer storage medium, and can continue to remember information stored on the communication device after the communication device is powered down.

The processor can be connected to the memory via a bus, and the like, and configured to read an executable program stored on the memory.

An embodiment of the present disclosure further provides a computer storage medium, where the computer storage medium stores a computer executable program, and the computer executable program, when executed by a processor, implements the method according to any embodiment of the present disclosure.

With regard to the apparatus in the above embodiment, the specific manner in which each module performs operations has been described in detail in the method embodiment, and will not be described in detail here.

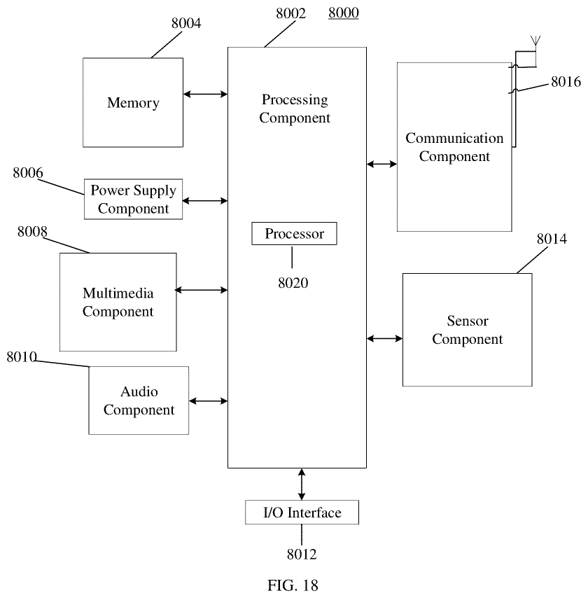

FIG. 18 is a block diagram illustrating a user equipment 8000 according to an exemplary embodiment. For example, the user equipment 8000 may be a mobile phone, a computer, a digital broadcast terminal, a messaging device, a game console, a tablet device, a medical device, a fitness device, a personal digital assistant, or the like.

Referring to FIG. 18, the user equipment 8000 can include one or more of the following components: a processing component 8002, a memory 8004, a power supply component 8006, a multimedia component 8008, an audio component 8010, an input/output (I/O) interface 8012, a sensor component 8014, and a communication component 8016.

The processing component 8002 generally controls the overall operations of user equipment 8000, for example, operations associated with display, phone calls, data communications, camera operations, and recording operations. The processing component 8002 can include one or more processors 8020 to execute instructions to complete all or part of the steps of the above-mentioned method. Additionally, the processing component 8002 can include one or more modules that facilitate interaction between the processing component 8002 and other components. For example, the processing component 8002 can include a multimedia module to facilitate interaction between the multimedia component 8008 and the processing component 8002.

The memory 8004 is configured to store various types of data to support operations at device 8000. Examples of such data include instructions for any application or method operating on the user equipment 8000, contact data, phonebook data, messages, pictures, videos, or the like. The memory 8004 may be implemented by any type of volatile or non-volatile storage device or a combination thereof, for example, static random-access memory (SRAM), electrically erasable programmable read-only memory (EEPROM), erasable Programmable read-only memory (EPROM), programmable read-only memory (PROM), read-only memory (ROM), magnetic memory, flash memory, magnetic or optical disk.

The power supply component 8006 provides power to various components of the user equipment 8000. The power supply components 8006 can include a power management system, one or more power supplies, and other components associated with generating, managing, and distributing power to the user equipment 8000.

The multimedia component 8008 includes a screen that provides an output interface between the user equipment 8000 and the user. In some embodiments, the screen can include a liquid crystal display (LCD) and a touch panel (TP). If the screen includes a touch panel, the screen may be implemented as a touch screen to receive input signals from the user. The touch panel includes one or more touch sensors to sense touches, swipes, and gestures on the touch panel. a touch sensor can not only sense the boundaries of a touch or swipe action, but also detect the duration and pressure associated with the touch or swipe action. In some embodiments, the multimedia component 8008 includes a front camera and/or a rear camera. When the device 8000 is in an operating mode, for example, a shooting mode or a video mode, the front camera and/or the rear camera may receive external multimedia data. Each front camera and rear camera can be a fixed optical lens system or have a focal length and optical zoom capabilities.

The audio component 8010 is configured to output and/or input audio signals. For example, the audio component 8010 includes a microphone (MIC) configured to receive external audio signals when the user equipment 8000 is in operating modes, for example, call mode, recording mode, and speech recognition mode. The received audio signal may be further stored in the memory 8004 or sent via the communication component 8016. In some embodiments, the audio component 8010 also includes a speaker for outputting audio signals.

The I/O interface 8012 provides an interface between the processing component 8002 and a peripheral interface module. The peripheral interface module may be a keyboard, a click wheel, a button, or the like. These buttons can include but are not limited to home button, volume buttons, start button, and lock button.

The sensor component 8014 includes one or more sensors that provide various aspects of status assessment for the user equipment 8000. For example, the sensor component 8014 can detect the open/closed state of the device 8000, and the relative positioning of components, for example, the display and keypad of the user equipment 8000. The sensor component 8014 can also detect the position change in the user equipment 8000 or a component in the user equipment 8000, the presence or absence of user contact with the user equipment 8000, the orientation or acceleration/deceleration of the user equipment 8000 and temperature changes of the user equipment 8000. The sensor component 8014 can include a proximity sensor configured to detect the presence of nearby objects without any physical contact. The sensor component 8014 may also include a light sensor, for example, a complementary metal oxide semiconductor (CMOS) or a charge coupled device (CCD) image sensor, for use in imaging applications. In some embodiments, the sensor component 8014 may also include an acceleration sensor, a gyroscope sensor, a magnetic sensor, a pressure sensor, or a temperature sensor.

The communication component 8016 is configured to facilitate wired or wireless communication between the user equipment 8000 and other devices. The user equipment 8000 may access a wireless network based on a communication standard, for example, Wi-Fi, 2G or 3G, or a combination thereof. In an embodiment, the communication component 8016 receives broadcast signals or broadcast related information from an external broadcast management system via a broadcast channel. In an embodiment, the communication component 8016 also includes a near field communications (NFC) module to facilitate short-range communications. For example, the NFC module can be implemented based on radio frequency identifier (RFID) technology, infrared data association (IrDA) technology, ultra-wideband (UWB) technology, Bluetooth (BT) technology and other technologies.

In an embodiment, the user equipment 8000 may be configured by one or more application specific integrated circuits (ASICs), digital signal processors (DSPs), digital signal processing devices (DSPDs), programmable logic devices (PLDs), field programmable gate arrays (FPGAs), controllers, microcontrollers, microprocessors or other electronic components to perform the steps of the above method for selecting the edge application server.

In an embodiment, a non-transitory computer-readable storage medium including instructions, for example, a memory 8004 including instructions, which can be executed by the processor 8020 of the user equipment 8000 to complete the steps of the above-mentioned method for selecting the edge application server is also provided. For example, non-transitory computer-readable storage media may be ROM, random access memory (RAM), CD-ROM, magnetic tape, floppy disk, optical data storage device, or the like.

Other embodiments of the present disclosure will be apparent to those skilled in the art from consideration of the specification and practice of the present disclosure disclosed here. The present disclosure is intended to cover any variations, uses, or adaptations of embodiments of the present disclosure following the general principles thereof and including such departures from embodiments of the present disclosure as come within known or customary practice in the art. It is intended that the specification and the examples be considered as illustrative only, with a true scope and spirit of the embodiments of the present disclosure being indicated by the following claims.

It is appreciated that embodiments of the present disclosure are not limited to the exact construction that has been described above and illustrated in the accompanying drawings, and that various modifications and changes may be made without departing from the scope thereof. It is intended that the scope of embodiments of the present disclosure only be limited by the appended claims.

1. A method for updating personal IoT network (PIN) information, executed by a first network function, the method comprising:
sending indication information to a second network function serving a PIN element (PINE),
wherein the indication information is configured to indicate updated PIN information, and the PINE is an element related to the updated PIN information.

2. The method according to claim 1, wherein the first network function comprises a PIN management function (PMF) or a policy control function (PCF), and the second network function comprises an access and mobility management function (AMF).

3. The method according to claim 2, further comprising:
determining to update PIN information, and sending request information to a third network function,
wherein the request information is configured to request information of the second network function.

4. The method according to claim 3, further comprising at least one of:
the third network function comprising a unified data management (UDM) function;
the request information indicating at least one of following information of the PINE: an identity identifier (ID) of a terminal, or a generic public subscription identifier (GPSI); or
determining to update the PIN information, and determining the PINE.

5. (canceled)

6. (canceled)

7. The method according to claim 1, further comprising:
determining that a predetermined event is triggered, and determining to update the PIN information,
wherein the predetermined event comprises at least one of:
a valid time of the PINE expires;
a PINE is added to a PIN;
the PINE leaves the PIN;
the PINE in the PIN is updated;
the valid time of the PINE is updated;
PIN policies are updated;
PIN configuration parameters are updated; or
a capability of the PINE is updated.

8. The method according to claim 3, further comprising:
receiving first response information sent by the third network function,
wherein the first response information comprises the information of the second network function serving the PINE;
wherein the information of the second network function comprises a second network function identifier (ID).

9. (canceled)

10. The method according to claim 1, wherein the first network function comprises a unified data management (UDM) function, and the second network function comprises an access and mobility management function (AMF);
wherein sending the indication information to the second network function serving the PINE comprises:
determining to update PIN information, and sending the indication information to the second network function serving the PINE.

11. (canceled)

12. The method according to claim 1, further comprising:
receiving second response information sent by the second network function.

13. The method according to claim 1, wherein the PINE comprises at least one of:
a PIN element with gateway capability (PEGC);
a PIN element with management capability (PEMC); or
a PIN element without gateway capability and management capability.

14. A method for updating personal IoT network (PIN) information, executed by a third network function, the method comprising:
receiving request information sent by a first network function,
wherein the request information is configured to request to obtain information of a second network function serving a PIN element (PINE), and the PINE is an element related to updated PIN information.

15. The method according to claim 14, further comprising at least one of:
the first network function comprising a PIN management function (PMF) or a policy control function (PCF), the second network function comprising an access and mobility management function (AMF), and the third network function comprising a unified data management (UDM) function;
the request information indicating at least one of following information: an identity identifier (ID) of a terminal; or a generic public subscription identifier (GPSI); or
the PINE comprising at least one of: a PIN element with gateway capability (PEGC); a PIN element with management capability (PEMC); or a PIN element without gateway capability and management capability.

16. (canceled)

17. The method according to claim 14, further comprising:
sending first response information to the first network function,
wherein the first response information comprises the information of the second network function serving the PINE.

18. The method according to claim 17, wherein the information of the second network function indicates an access and mobility management function (AMF) ID.

19. (canceled)

20. A method for updating personal IoT network (PIN) information, executed by a second network function, the method comprising:
receiving indication information sent by a first network function,
wherein the indication information is configured to indicate updated PIN information, the second network function serves a PIN element (PINE), and the PINE is an element related to the updated PIN information.

21. The method according to claim 20, wherein the first network function comprises a PIN management function (PMF), a policy control function (PCF) or a unified data management (UDM) function, and the second network function comprises an access and mobility management function (AMF).

22. The method according to claim 20, further comprising:
sending the indication information to a PIN element with management capability (PEMC).

23. The method according to claim 22, further comprising:
receiving second response information sent by the PEMC; and
sending the second response information to the first network function.

24.-30. (Canceled)

31. A communication device, comprising:
a memory; and
one or more processors connected to the memory and configured to perform, by executing instructions stored on the memory, the method according to claim 1.

32. (canceled)

33. A communication device, comprising:
a memory; and
one or more processors connected to the memory and configured to perform, by executing instructions stored on the memory, the method according to claim 14.

34. A communication device, comprising:
a memory; and
one or more processors connected to the memory and configured to perform, by executing instructions stored on the memory, the method according to claim 20.
